(19) United States
(12) Patent Application Publication
(10) Pub. No.: US 2025/0321589 A1
(43) Pub. Date: Oct. 16, 2025

(54) UNMANNED AERIAL VEHICLE, UNMANNED AERIAL VEHICLE CONTROL SYSTEM, AND UNMANNED AERIAL VEHICLE CONTROL METHOD

(71) Applicant: Kubota Corporation, Osaka (JP)

(72) Inventor: Kohei SEINO, Sakai-shi (JP)

(21) Appl. No.: 19/248,041

(22) Filed: Jun. 24, 2025

Related U.S. Application Data
(63) Continuation of application No. PCT/JP2022/048162, filed on Dec. 27, 2022.

(51) Int. Cl. G05D 1/622; G05D 109/25; G05D 111/10

(52) U.S. Cl. CPC G05D 1/622; G05D 2109/254; G05D 2111/17

(57) ABSTRACT

A controller for a multicopter is configured or programmed to perform an obstacle avoidance function to detect an obstacle based on a signal output from an obstacle sensor and to perform operations to avoid collision with the obstacle. The controller is configured or programmed to disable the obstacle avoidance function when a predetermined condition is satisfied, and enable the obstacle avoidance function when the predetermined condition is not satisfied. The predetermined condition includes at least one of a first condition that a tilt angle of a body is greater than a predetermined angle, a second condition that the unmanned aerial vehicle is in a takeoff operation or a landing operation, or a third condition that an altitude of the body is at or below a predetermined height.

### CROSS REFERENCE TO RELATED APPLICATIONS

This application is a Continuation Application of PCT Application No. PCT/JP2022/048162 filed on Dec. 27, 2022. The entire contents of this application are hereby incorporated herein by reference.

### BACKGROUND OF THE INVENTION

### 1. Field of the Invention

The present disclosure relates to unmanned aerial vehicles, and control systems and control methods for unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Many unmanned aerial vehicles used for industrial applications such as agriculture have obstacle detection functions. Such unmanned aerial vehicles perform operations to avoid collisions when obstacles are detected. International Publication No. WO 2020/162586 discloses an example of an unmanned aerial vehicle with obstacle detection function.

### SUMMARY OF THE INVENTION

In unmanned aerial vehicles with functions to detect and avoid obstacles, the collision avoidance function may unnecessarily restrict the flight of the unmanned aerial vehicle depending on the situation.

Example embodiments of the present disclosure provide control technologies to reduce or prevent unnecessary restriction of unmanned aerial vehicle flights by collision avoidance functions.

In a non-limiting example embodiment of the present disclosure, an unmanned aerial vehicle includes a body, an obstacle sensor attached to the body, and a controller configured or programmed to perform an obstacle avoidance function to detect an obstacle based on a signal output from the obstacle sensor and to perform an operation to avoid collision with the obstacle, disable the obstacle avoidance function when a predetermined condition is satisfied, and enable the obstacle avoidance function when the predetermined condition is not satisfied. The predetermined condition includes at least one of a first condition that a tilt angle of the body is greater than a predetermined angle, a second condition that the unmanned aerial vehicle is in a takeoff operation or a landing operation, or a third condition that an altitude of the body is at or below a predetermined height.

According to the example embodiments of the present disclosure, it is possible to reduce or prevent unnecessary restriction of unmanned aerial vehicle flights by collision avoidance functions.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid drive type multicopter.

FIG. 2C is a block diagram showing a basic configuration example of a parallel hybrid drive type multicopter.

FIG. 3 is a block diagram schematically showing a configuration example of a multicopter with obstacle avoidance function.

FIG. 4 is a side view schematically showing an example of a multicopter including an obstacle sensor.

FIG. 5 is a diagram schematically showing the operation of a multicopter 10 detecting an obstacle 92 during flight. In the example of FIG. 5, the multicopter 10 is flying in the direction of the white arrow, and there is an obstacle 92 (in this case, a tree) in front of the multicopter 10.

FIG. 6 is a diagram explaining obstacle detection when the multicopter is tilted.

FIG. 7 is a flowchart showing an example of operations performed by the controller.

FIG. 8 is a flowchart showing another example of operations performed by the controller.

FIG. 9 is a flowchart showing yet another example of operations performed by the controller.

FIG. 10 is a diagram schematically showing an example of a method for determining the altitude of the body.

FIG. 11 is a block diagram showing an example of the hardware configuration of the controller.

FIG. 12 is a schematic diagram showing a configuration example of a system including the multicopter.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

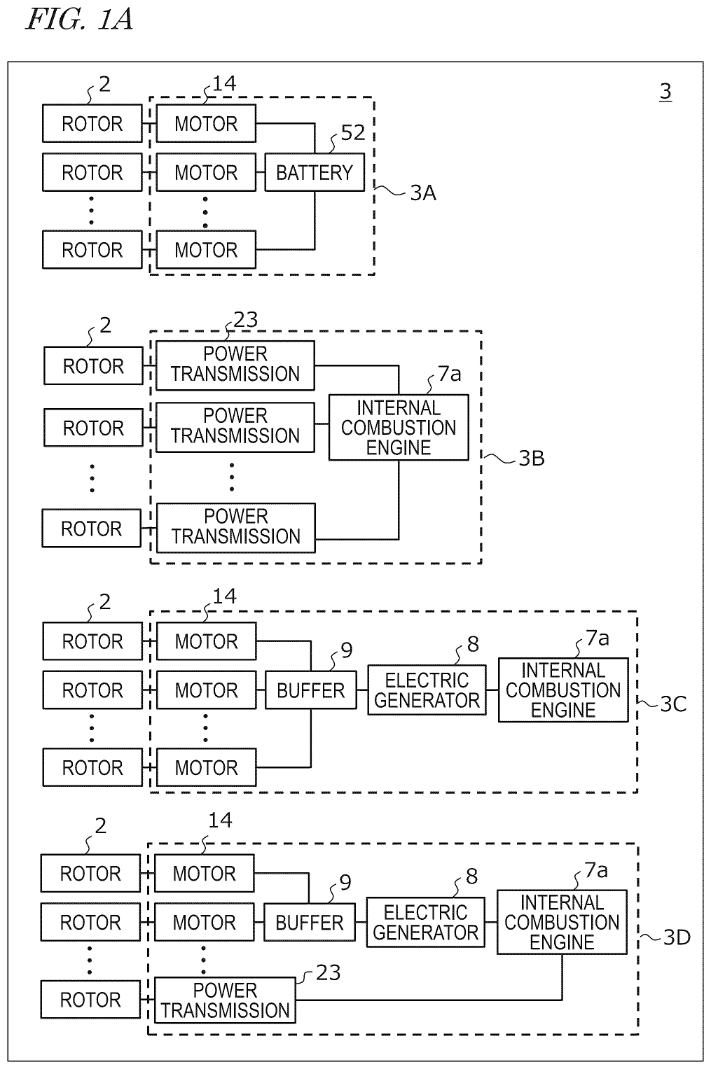

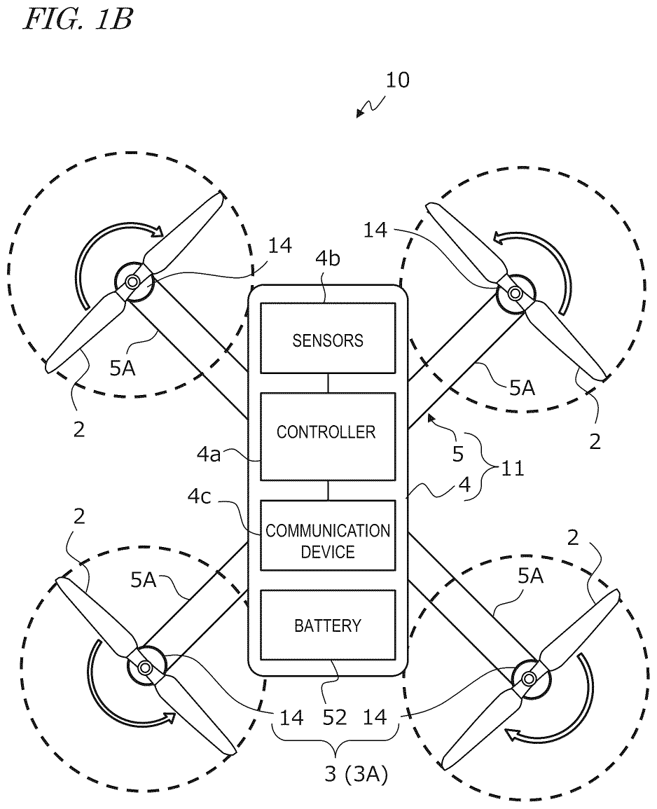

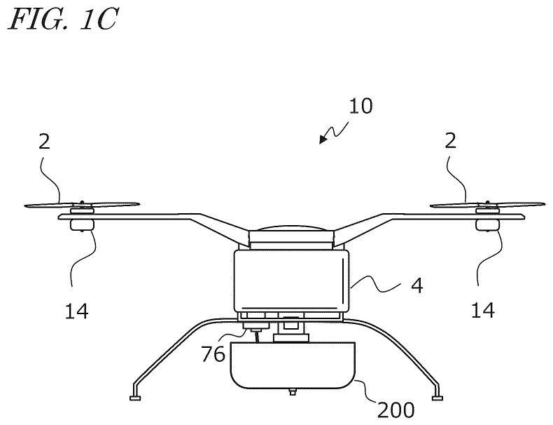

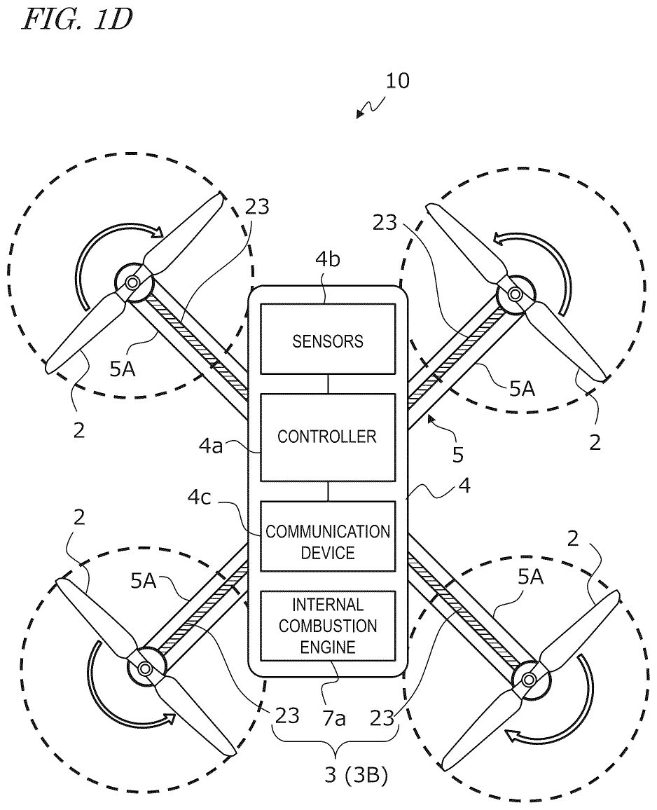

The configuration of rotation drivers included in multicopters exists in various forms. FIG. 1A is a schematic block diagram showing four examples of rotation drivers 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides a driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides a driving force to the electric generator 8 for power generation, a power transmission system 23 that transmits the driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imager, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used to measure distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute part or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned further inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism to change the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used to both generate thrust and attitude control. The main rotors may be called “booster rotors” and the sub-rotors may be called “attitude control rotors”.

In the parallel hybrid driver, the internal combustion engine is used for both thrust generation and power generation. By selectively transmitting a driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt parallel hybrid driver or series hybrid driver to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes a power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery for storing power.

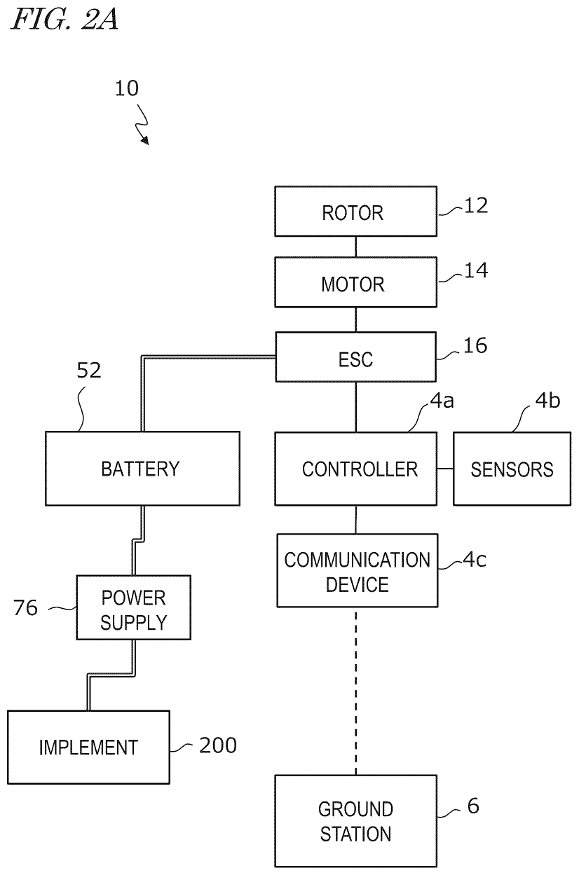

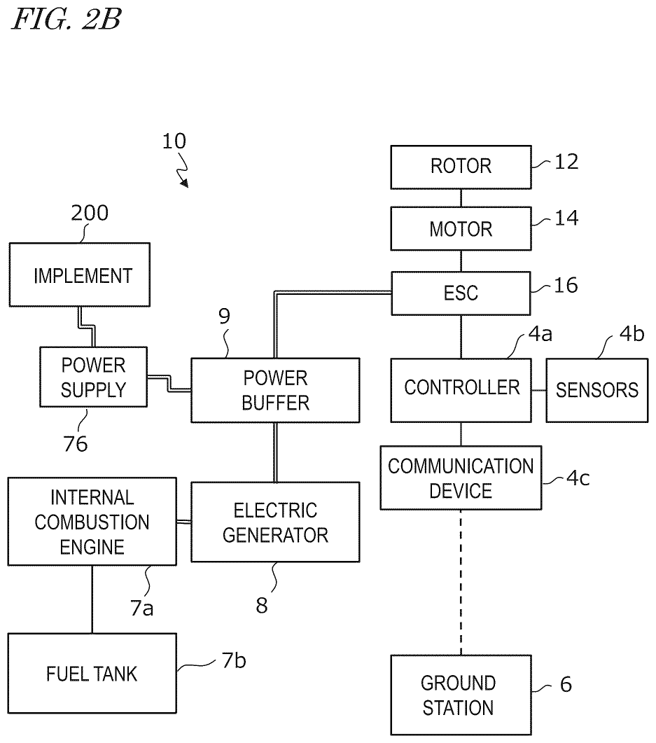

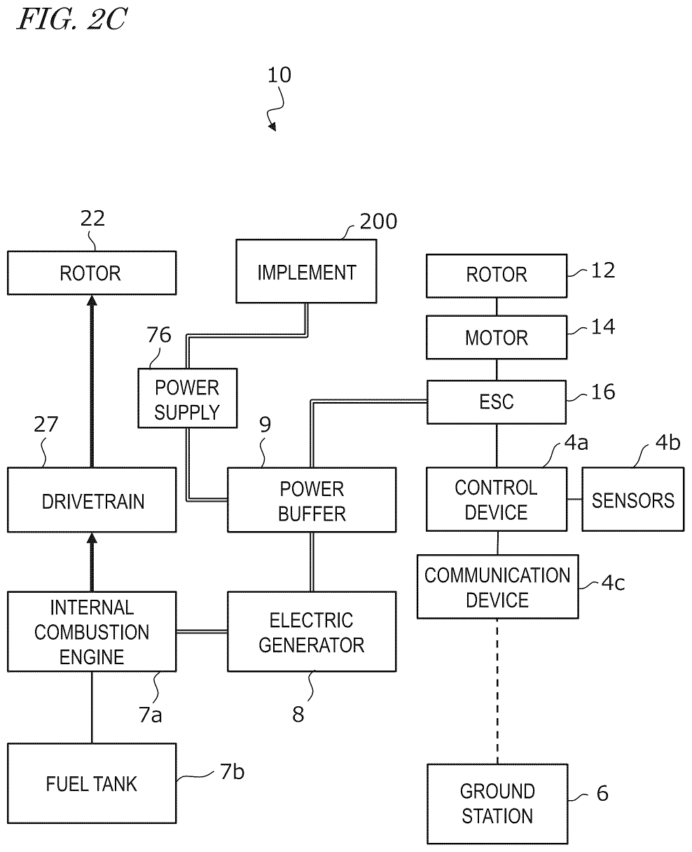

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's remote controller on the ground. The controller 4a may have functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless methods or mechanisms.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76. FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits a driving force from the internal combustion engine 7a, and the rotor 22 that rotates upon the receiving the driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

As described above, the configurations of multicopter 10 are diverse. In any configuration, the multicopter 10 may include a function to detect and avoid obstacles. Such a function is called an “obstacle avoidance function” in this specification. The following describes an example of a multicopter 10 including an obstacle avoidance function.

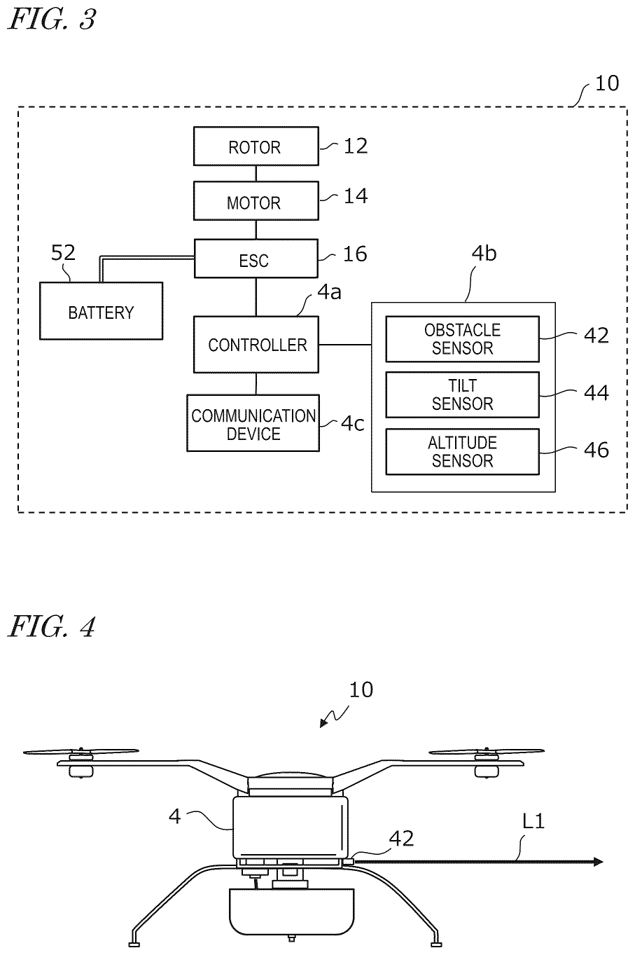

FIG. 3 is a block diagram schematically showing a configuration example of a multicopter 10 with an obstacle avoidance function. The multicopter 10 shown in FIG. 3 includes components similar to those of the multicopter 10 shown in FIG. 2A. However, the power supply 76 and work machine 200 shown in FIG. 2A are omitted from FIG. 3. FIG. 3 shows examples of sensors 4b including an obstacle sensor 42, a tilt sensor 44, and an altitude sensor 46. The operation of the multicopter 10 is controlled by a control system including the controller 4a.

In FIG. 3, for simplicity, the rotor 12, the motor 14, and the ESC 16 are each shown by a single block, but the numbers of rotors 12, motors 14, and ESCs 16 are each plural. Additionally, although not shown in FIG. 3, the multicopter 10 may include an internal combustion engine 7a, a fuel tank 7b, and an electric generator 8 as shown in FIGS. 2B or 2C. Furthermore, as shown in FIG. 2C, the multicopter may include at least one rotor 22 driven by the internal combustion engine 7a. In that case, either the “series hybrid” or “parallel hybrid” drive format may be adopted.

The multicopter 10 includes one or more obstacle sensors 42. The obstacle sensor 42 may be, for example, a laser sensor (such as a laser range finder or LiDAR sensor), an ultrasonic sensor, or an imager, or any combination of these. Multiple obstacle sensors 42 may be attached to different positions on the body (main body 4 or body frame 5). Alternatively, when a work machine 200 is connected to the body as shown in the example of FIG. 1C, one or more obstacle sensors 42 may be attached to the work machine 200.

The obstacle sensor 42 may be positioned to detect objects horizontally spaced away from the body (e.g., in a direction parallel to the ground) when the body is not tilted. Here, “when the body is not tilted” refers to a state where the multicopter 10 is in a posture (hereinafter referred to as the “reference posture”) where the rotation axes of each rotor are parallel or substantially parallel to the vertical direction. For example, the state where the multicopter 10 is hovering in a windless environment corresponds to a state where the body is not tilted.

When the obstacle sensor 42 includes a laser sensor, the laser sensor may be fixed to the body so as to emit a light beam toward an object horizontally positioned from the body when the body is not tilted. The laser sensor may be configured to output a signal indicating the distance or position to one or more objects within a measurable range from the position of the body or laser sensor.

When the obstacle sensor 42 includes an imager, the imager may be fixed to the body so as to capture images of objects horizontally positioned from the body when the body is not tilted. An imager capable of measuring distance to the subject, such as a stereo camera, may be used as the imager. The imager may be configured to output a signal indicating the captured image, or a signal including information on the distance to one or more subjects included in the captured image.

The tilt sensor 44 measures the tilt angle of the body of the multicopter 10 and outputs a signal indicating the tilt angle. The tilt angle represents the magnitude of inclination relative to the reference posture mentioned above. The tilt sensor 44 may include, for example, an acceleration sensor or an IMU including an acceleration sensor.

The altitude sensor 46 measures the altitude of the body of the multicopter 10 and outputs a signal indicating the altitude. The altitude refers to the vertical distance between a reference plane (e.g., the ground surface) and the body. The altitude sensor 46 may include, for example, a barometer, a GNSS receiver, or a distance sensor that measures the distance from the body to the ground, or a combination of these.

FIG. 4 is a side view schematically showing an example of a multicopter 10 including an obstacle sensor 42. The obstacle sensor 42 is attached to the main body 4 of multicopter 10 shown in FIG. 4. In this example, the obstacle sensor 42 is a laser sensor that emits a light beam L1 in the horizontal direction when the body is not tilted. This obstacle sensor 42 may include a light source that emits the light beam L1, a photodetector that detects light returned when the light beam L1 is reflected from the surface of an object, and a processor configured or programmed to calculate the distance to the reflection point. The processor may be configured or programmed to calculate the distance to the reflection point using technology such as ToF (Time of Flight) and output a signal indicating the distance. Such obstacle sensors 42 may be placed, for example, at four or more locations around the front, back, left, and right of the body of the multicopter 10.

The controller 4a detects obstacles based on signals output from the obstacle sensor 42. Here, “detecting obstacles” means detecting that an obstacle exists within a range where the distance from the body or the obstacle sensor 42 is less than or equal to a threshold value. The threshold value may be, for example, 20 meters (m), 30 m, or 40 m. The threshold value may be a fixed value or a variable value. When an obstacle is detected, the controller 4a causes the multicopter 10 to perform an obstacle avoidance operation to avoid collision with the obstacle. This function is called the “obstacle avoidance function”. The obstacle avoidance operation may include actions such as invalidating commands to approach the obstacle and hovering in place, or changing the flight path to move away from the obstacle.

In this example embodiment, the controller 4a does not always enable the obstacle avoidance function but disables the obstacle avoidance function when a predetermined condition is satisfied. For example, the controller 4a may be configured or programmed to disable the obstacle avoidance function when at least one of the following applies: (a) the tilt angle of the body is greater than a predetermined angle, (b) a takeoff operation or a landing operation (hereinafter may be collectively referred to as “takeoff or landing operation”) is being performed, or (c) the altitude of the multicopter 10 is at or below a predetermined height. In other words, the predetermined condition includes at least one of the following first, second, and third conditions:
First condition: The tilt angle of the body is greater than a predetermined angle;
Second condition: The multicopter 10 is in a takeoff operation or a landing operation;
Third condition: The altitude of the body is at or below a predetermined height.

The controller 4a disables the obstacle avoidance function when the predetermined condition including at least one of these conditions is satisfied, and enables the obstacle avoidance function when the predetermined condition is not satisfied. For example, when the tilt angle of the body exceeds the predetermined angle during a takeoff or landing operation, the controller 4a may disable the obstacle avoidance function. In that case, the predetermined condition includes the first condition and the second condition, but not the third condition. Alternatively, when the altitude of the body is at or below the predetermined height during a takeoff or landing operation, the controller 4a may disable the obstacle avoidance function. In that case, the predetermined condition includes the second condition and the third condition, but not the first condition. These examples are not limiting. For instance, when the tilt angle of the body exceeds the predetermined angle, and the altitude of the body is at or below the predetermined height during a takeoff or landing operation, the controller 4a may disable the obstacle avoidance function. In that case, the predetermined condition includes all three conditions: the first condition, the second condition, and the third condition.

Such operations can avoid situations where, for example, during a takeoff or landing when the distance between the multicopter 10 and the ground is close, the body tilts and mistakenly detects the ground as an obstacle, resulting in unnecessary restriction of movement.

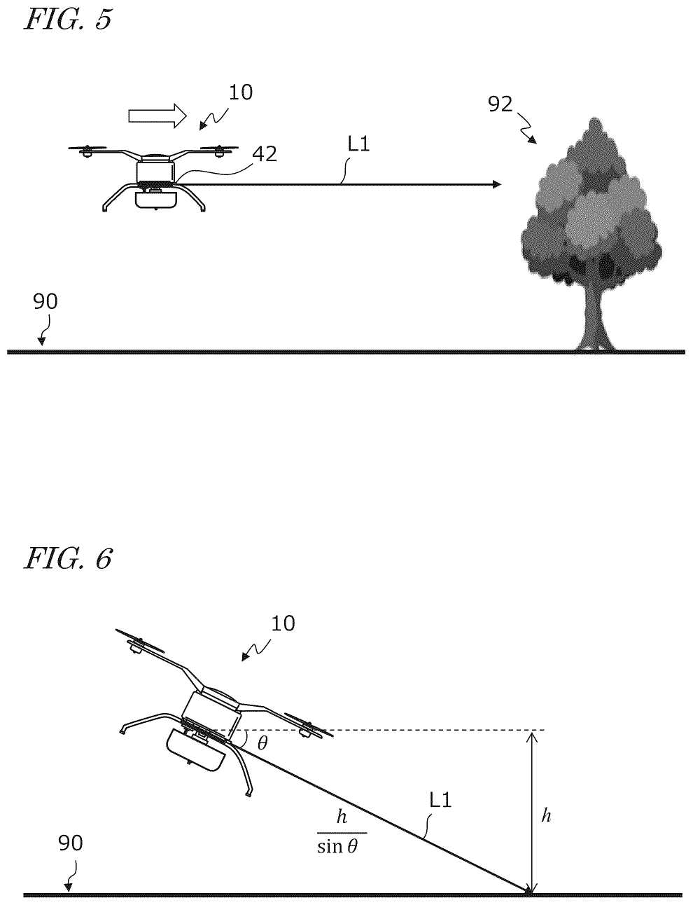

FIG. 5 is a diagram schematically showing the operation of a multicopter 10 detecting an obstacle 92 during flight. In the example of FIG. 5, the multicopter 10 is flying in the direction of the white arrow, and there is an obstacle 92 (in this case, a tree) in front of the multicopter 10.

The controller 4a can fly the multicopter 10 along a predetermined target path based on position information output from a GNSS receiver. Such an operation mode is called an “autonomous operation mode”. The controller 4a can also operate in a “manual operation mode” where it flies the multicopter 10 in response to commands from a controller used by a user. In this example embodiment, the multicopter 10 may fly in either autonomous operation mode or manual operation mode.

The multicopter 10 in the example of FIG. 5 includes a laser sensor such as a LIDAR sensor as the obstacle sensor 42, which emits a light beam L1 toward the front of the body. This obstacle sensor 42 outputs a signal indicating the distance to objects within its measurement range. The controller 4a detects the presence of an obstacle 92 in front of the multicopter 10 based on the signal output from the obstacle sensor 42 indicating the distance to the obstacle 92. For example, the controller 4a determines that an obstacle has been detected if the distance indicated by the signal (hereinafter sometimes referred to as the “measured distance”) is less than a threshold value. When the controller 4a detects the obstacle 92, it can avoid collision with the obstacle 92 by stopping the movement of the multicopter 10 and having it hover in place, or by moving the multicopter 10 away from the obstacle 92.

Here, when the body is tilted in a state where the altitude of the multicopter 10 is low, such as during takeoff or landing operations, as shown in FIG. 6, the light beam L1 may be directed at the ground 90, causing the ground 90 to be detected as an obstacle. If the tilt angle of the body is θ and the altitude of the body is h, the measured distance to the ground 90 is represented by h/sin θ. The tilt angle θ is measured by the tilt sensor 44, and the altitude h is measured by the altitude sensor 46. When the multicopter 10 is tilted around an axis extending in the left-right direction (for example, when moving forward or backward), the tilt angle θ represents the pitch angle. When the multicopter 10 is tilted around an axis extending in the front-back direction (for example, when moving left or right), the tilt angle θ represents the roll angle. The tilt angle θ correlates with the movement speed of the multicopter 10. Therefore, the tilt sensor 44 may calculate the tilt angle θ based on the movement speed of the multicopter 10.

If an obstacle is detected when the measured distance is smaller than the threshold value, the ground 90 is more likely to be detected as an obstacle the smaller the altitude h or the larger the tilt angle θ. However, there are cases where even if the ground 90 is detected, it does not affect the flight, such as when the multicopter 10 is performing a takeoff or landing operation. Performing obstacle avoidance operations in such cases would unnecessarily restrict the multicopter 10's operation.

Therefore, the controller 4a of the present example embodiment determines whether to enable the obstacle avoidance function based on the measured value of the tilt angle θ, the measured value of the altitude h, or whether it is in a takeoff or landing operation, or a combination thereof. This can prevent unnecessary restriction of the multicopter 10's flight by obstacle avoidance operations.

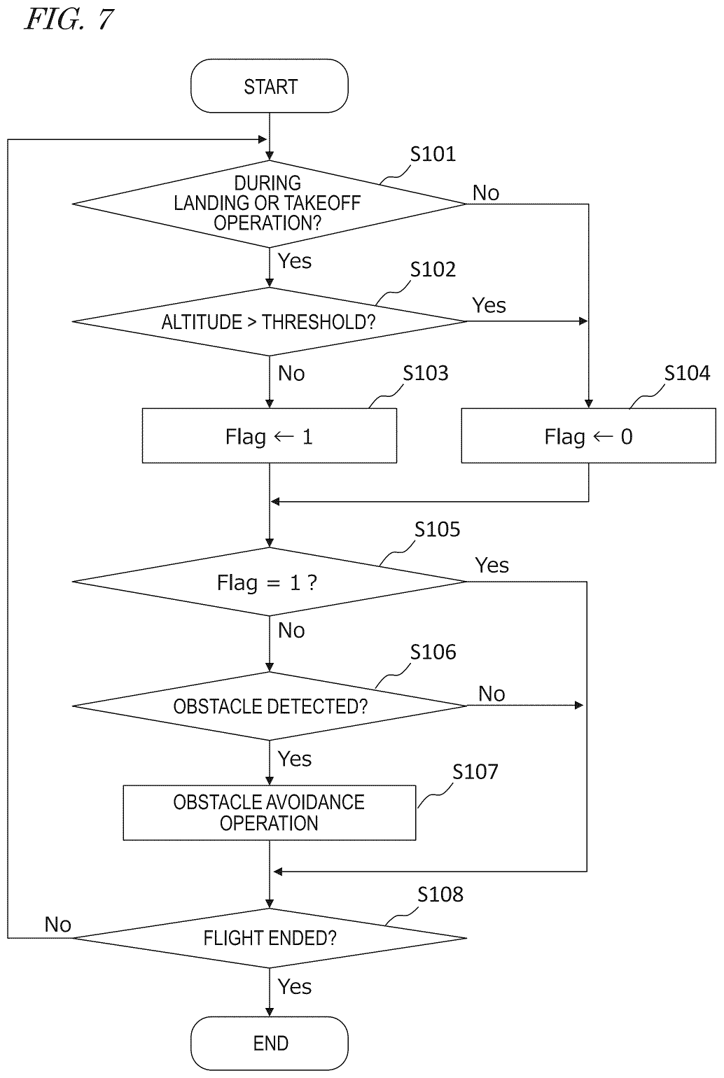

FIG. 7 is a flowchart showing an example of operations performed by the controller 4a. In the example shown in FIG. 7, the controller 4a is configured or programmed to perform the following steps S101 to S108 during the flight of the multicopter 10. Note that the operations shown in FIG. 7 can be applied when the multicopter 10 flies in either autonomous operation mode or manual operation mode.

In step S101, the controller 4a determines whether it is in a takeoff or landing operation. The takeoff or landing operation is an operation to take off or land the multicopter 10 according to user piloting or a pre-set flight program. In the takeoff operation, the controller 4a raises the multicopter 10 to a specified or preset altitude (for example, 3 meters, 5 meters, 10 meters, etc.). After the takeoff operation, the controller 4a flies the multicopter 10 according to user piloting or a pre-set flight program. In the landing operation, the controller 4a lowers the multicopter 10 toward the ground, for example vertically, and lands it. If it is in a takeoff or landing operation in step S101, the process proceeds to step S102; if not, the process proceeds to step S104.

In step S102, the controller 4a determines whether the altitude of the body measured by the altitude sensor 46 exceeds a threshold value. The threshold value may be set to a value lower than the altitude at which the multicopter 10 normally flies, for example, 1 meter, 2 meters, 3 meters, etc. If the measured altitude does not exceed the threshold value, the process proceeds to step S103. If the measured altitude exceeds the threshold value, the process proceeds to step S104. Note that the order of the determinations in steps S101 and S102 may be reversed.

In step S103, the controller 4a sets a flag (Flag) indicating whether to disable the obstacle avoidance function to “1”. Flag “1” indicates disabling the obstacle avoidance function. After step S103, the process proceeds to step S105.

In step S104, the controller 4a sets the flag indicating whether to disable the obstacle avoidance function to “0”. Flag “0” indicates enabling the obstacle avoidance function. After step S104, the process proceeds to step S105.

In step S105, the controller 4a determines whether the flag is 1, that is, whether to perform obstacle avoidance operations. If the flag is 1, it proceeds to step S108 without performing obstacle avoidance operations. If the flag is not 1 (i.e., it is 0), it proceeds to step S106.

In step S106, the controller 4a determines whether there is an obstacle based on signals output from the obstacle sensor 42. For example, the controller 4a determines whether the measured distance indicated by the signal output from the obstacle sensor 42 is less than a threshold value. If the measured distance is less than the threshold value, it determines that an obstacle has been detected. If the measured distance is equal to or greater than the threshold value, it determines that no obstacle has been detected. The threshold value may be a pre-set fixed value or a variable value. For example, the controller 4a may set the threshold value for the measured distance for obstacle detection based on the tilt angle θ measured by the tilt sensor 44 and the altitude h measured by the altitude sensor 46. As shown in FIG. 6, when the obstacle sensor 42 measures the distance to a flat ground 90, the measured distance is represented by h/sin θ. However, the ground 90 is not always flat. Also, there is a possibility that obstacles that should be avoided exist on or above the ground 90. If the measured distance is equal to h/sin θ, it is only detecting the ground 90, and there is no need to restrict horizontal movement. Also, if the measured distance is greater than h/sin θ, the altitude would be greater than h when moving horizontally to the point where the distance was measured, so there is no need to restrict horizontal movement. In contrast, if the measured distance is less than h/sin θ, there is an obstacle on or above the ground 90 in the forward direction of the multicopter 10, so avoidance is necessary. Therefore, the controller 4a may set the threshold value for the distance for obstacle detection to h/sin θ. Alternatively, the controller 4a may vary the threshold value for the distance for obstacle detection according to the value of h/sin θ. Such threshold setting can prevent the ground from being detected as an obstacle, thereby reducing or preventing unnecessary obstacle avoidance operations.

In step S107, the controller 4a performs obstacle avoidance operations. For example, the controller 4a adjusts the rotation speed of each rotor so that the multicopter 10 moves away from the obstacle or does not approach the obstacle any further. After step S107, the process proceeds to step S108.

In step S108, the controller 4a determines whether the flight has ended. The controller 4a may determine that the flight has ended, for example, in response to a flight end command, or after completing an autonomous flight along a pre-set flight path and completing the operation of landing at a predetermined landing point. The flight end command may be transmitted, for example, from a computer used by a pilot operating the multicopter 10 or a supervisor remotely monitoring the multicopter 10. If the flight has ended, the controller 4a ends its operation. If the flight has not ended, it returns to step S101. The above operations are repeated until it is determined that the flight has ended in step S108.

According to the above operations, if the multicopter 10 is in a takeoff or landing operation and the altitude of the multicopter 10 is at or below the threshold value (i.e., the predetermined height), the flag is set to “1”, and the obstacle avoidance function is disabled. Conversely, if the multicopter 10 is not during a takeoff or landing operation, or if the altitude of the multicopter 10 exceeds the threshold value, the flag is set to “0”, and the obstacle avoidance function is enabled. This can prevent unnecessary avoidance operations from being triggered when the ground is mistakenly detected as an obstacle due to the body tilting when the altitude of the multicopter 10 is low during a takeoff or landing operation.

In the example of FIG. 7, obstacle avoidance operations are disabled when the second condition (during takeoff or landing operations) and the third condition (the altitude of the body is at or below the predetermined height) among the aforementioned first, second, and third conditions is satisfied. This is not limiting. For example, obstacle avoidance operations may be disabled when the first condition (the tilt angle of the body is greater than the predetermined angle) and the second condition are satisfied. Alternatively, obstacle avoidance operations may be disabled when all of the first, second, and third conditions is satisfied.

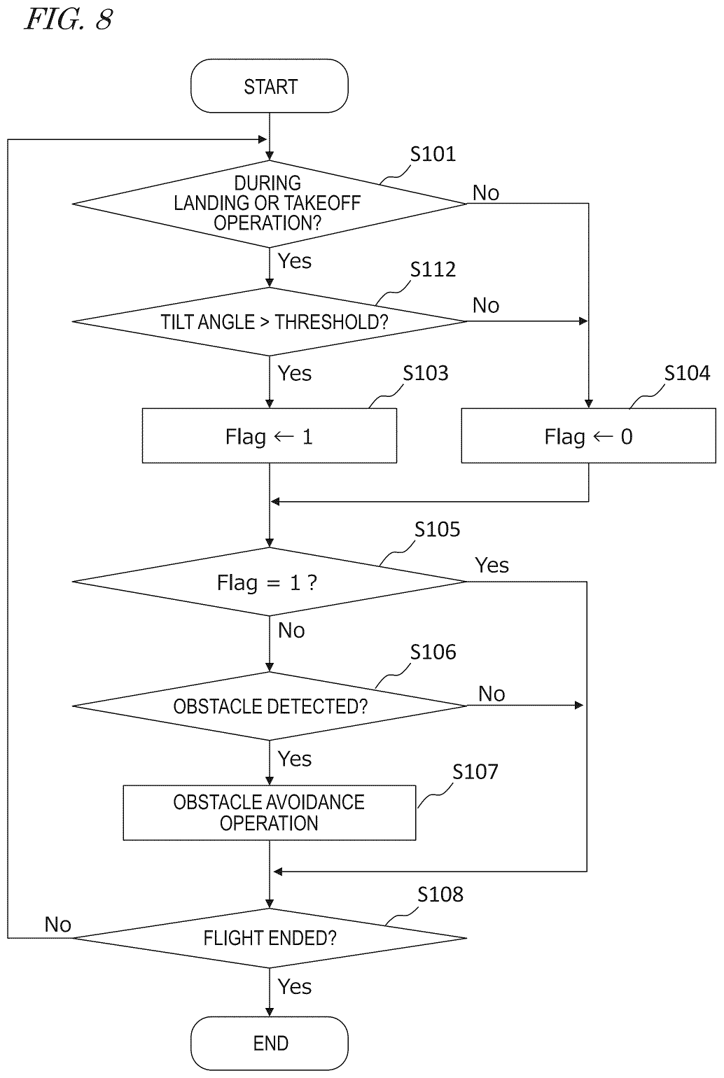

FIG. 8 is a flowchart showing an example of operations where obstacle avoidance operations are disabled when the first condition and the second condition is satisfied. The only difference between the operations shown in FIG. 8 and those shown in FIG. 7 is that step S102 has been replaced with step S112. In the example of FIG. 8, when the controller 4a determines that it is in a takeoff or landing operation in step S101, it proceeds to step S112 and determines whether the tilt angle of the body measured by the tilt sensor 44 is greater than a threshold value (i.e., the predetermined angle). The threshold value may be set to any angle, for example, 20 degrees, 30 degrees, 40 degrees, etc. If the tilt angle is greater than the threshold value, it proceeds to step S103; if the tilt angle is less than or equal to the threshold value, it proceeds to step S104. The subsequent operations are the same as in the example of FIG. 7. Note that the order of the determinations in steps S101 and S112 may be reversed.

In the example of FIG. 8, obstacle avoidance operations are disabled when the multicopter 10 is in a takeoff or landing operation and the tilt angle of the body is greater than the threshold value. Otherwise, obstacle avoidance operations are enabled. Such operations can prevent unnecessary avoidance operations from being triggered when the ground is mistakenly detected as an obstacle even when the body is significantly tilted during a takeoff or landing operation.

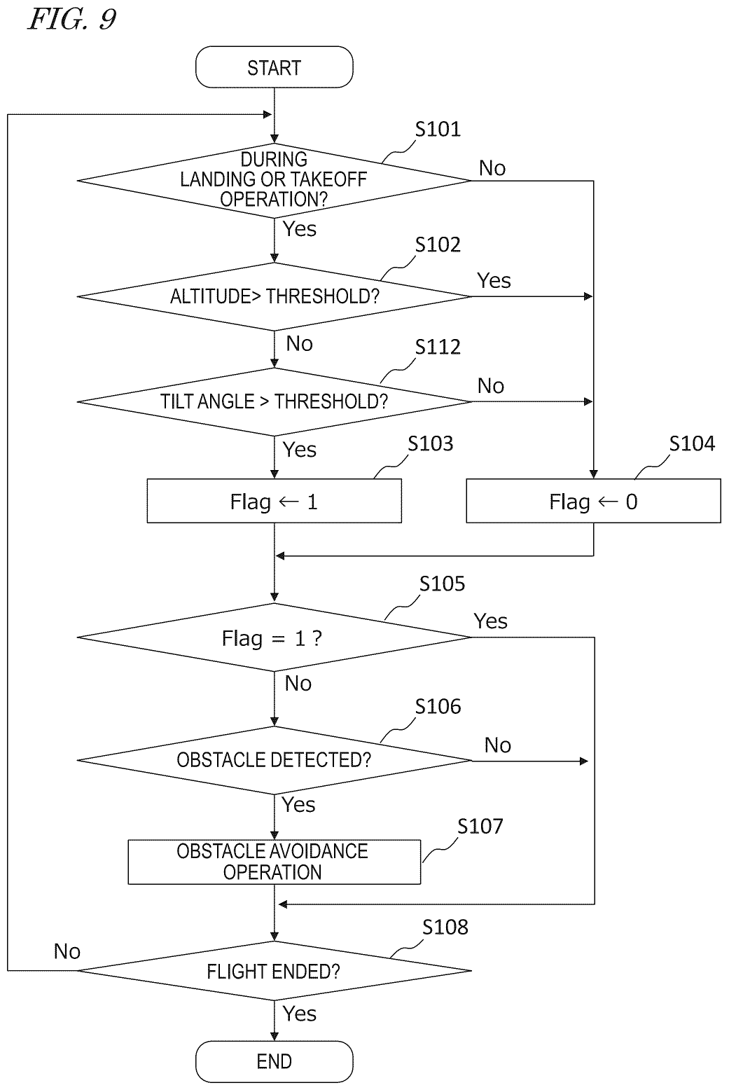

FIG. 9 is a flowchart showing an example of operations where obstacle avoidance operations are disabled when all of the first, second, and third conditions are satisfied. The only difference between the operations shown in FIG. 9 and those shown in FIG. 7 is that step S112 has been added between steps S102 and S103. Step S112 is the same operation as step S112 in FIG. 8. In the example of FIG. 9, when the controller 4a determines that the altitude of the body is at or below the threshold value (predetermined height) in step S102, it proceeds to step S112 and determines whether the tilt angle of the body is greater than the threshold value (predetermined angle). If the tilt angle is greater than the predetermined angle, it proceeds to step S103; if the tilt angle is less than or equal to the predetermined angle, it proceeds to step S104. The subsequent operations are the same as in the examples of FIGS. 7 and 8. Note that the order of the determinations in steps S101, S102, and S112 may be interchanged with each other.

In the example of FIG. 9, obstacle avoidance operations are disabled when the multicopter 10 is in a takeoff or landing operation, the altitude of the body is at or below the predetermined height, and the tilt angle of the body is greater than the predetermined angle; otherwise, obstacle avoidance operations are enabled. Such operations can prevent unnecessary avoidance operations from being triggered when the ground is mistakenly detected as an obstacle even when the altitude of the body is low and the body is significantly tilted during a takeoff or landing operation.

In the examples of FIG. 7, FIG. 8, and FIG. 9, obstacle avoidance operations are disabled only when the multicopter 10 is in a takeoff or landing operation, and are not disabled when not during a takeoff or landing operation. Instead of such examples, the controller 4a may determine whether to enable obstacle avoidance operations based on at least one of the altitude and tilt of the body, regardless of whether the multicopter 10 is in a takeoff or landing operation. For example, the controller 4a may disable obstacle avoidance operations if the altitude of the body is at or below the predetermined height or if the tilt angle of the body is greater than the predetermined angle, regardless of whether it is in a takeoff or landing operation.

In the above examples, the “altitude” of the body refers to the height from the ground to the body, but this is not limiting. For example, when the multicopter 10 flies over crops in a field, the distance from the body to the highest part of the crops may be treated as the “altitude”. In that case, the sensors 4b of the multicopter 10 may include a distance sensor that measures the distance from the body of the multicopter 10 to the crops. Such a distance sensor may be used as the altitude sensor 46 shown in FIG. 3.

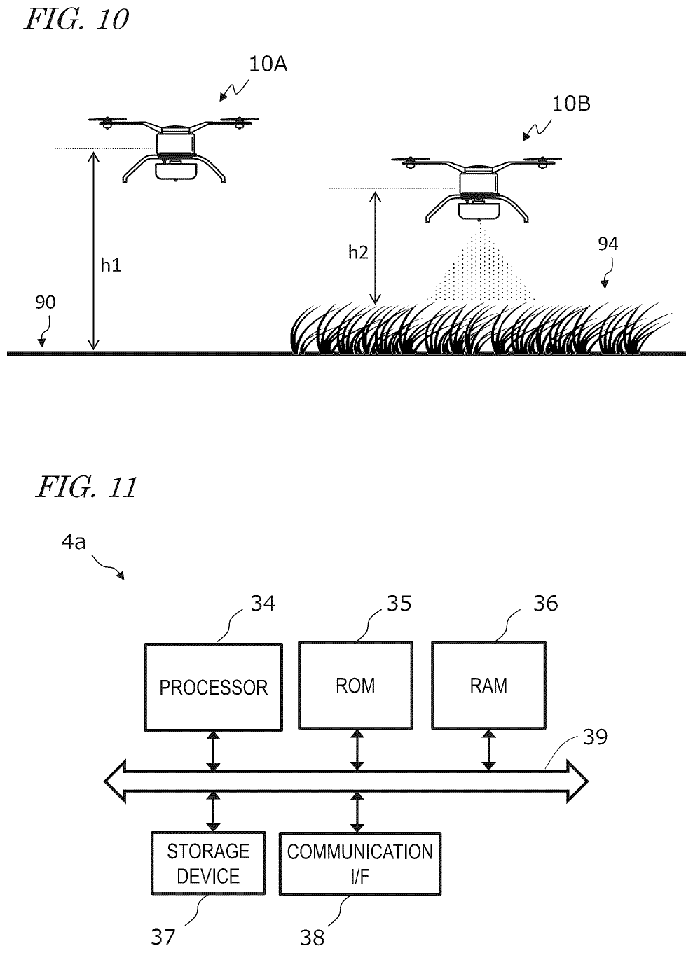

FIG. 10 is a diagram schematically showing an example of a method for determining the altitude of the body. FIG. 10 illustrates a multicopter 10A flying above the ground 90 and a multicopter 10B flying above crops 94 while performing agricultural work such as spraying. Multicopters 10A and 10B both have configurations similar to the multicopter 10 described above. In this example, the altitude sensor 46 includes a distance sensor that measures the distance to objects below the body as the altitude. Multicopter 10A flies above the ground 90 where no crops are growing, so the altitude sensor 46 of multicopter 10A measures the distance from the body to the ground 90 as altitude h1. Multicopter 10B flies above an area where crops 94 are growing, so the altitude sensor 46 of multicopter 10B measures the distance from the body to the top of the crops 94 as altitude h2. The controller 4a of multicopter 10B may determine whether to enable the obstacle avoidance operations based on altitude h2 instead of altitude h1. In that case, even if crops 94 rather than the ground 90 are detected as obstacles, avoidance operations will not be performed. This can reduce or prevent unnecessary avoidance operations from being triggered when crops 94 are detected as obstacles when the body is tilted while flying at a height close to the crops 94.

The controller 4a of the present example embodiment of the present disclosure may include a digital computer system programmed to execute each of the processes explained with reference to FIGS. 7 to 9.

FIG. 11 is a block diagram showing an example of the hardware configuration of the controller 4a. The controller 4a includes a processor 34, ROM (Read Only Memory) 35, RAM (Random Access Memory) 36, storage device 37, and communication I/F 38. These components are interconnected via a bus 39.

The processor 34 is one or more semiconductor integrated circuits, also referred to as a central processing unit (CPU) or microprocessor. The processor 34 sequentially executes computer programs stored in ROM 35 to implement the aforementioned processing. The processor 34 is broadly interpreted to include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Part of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, and various sensor data acquired by the multicopter 10 during flight.

Note that, as mentioned earlier, the controller 4a may be configured or programmed to include, as separate components, a flight controller such as a flight controller and an upper-level computer (companion computer). The companion computer may execute each of the processes shown in FIGS. 7 to 9 and provide flight-related commands to the flight controller based on the results of those processes.

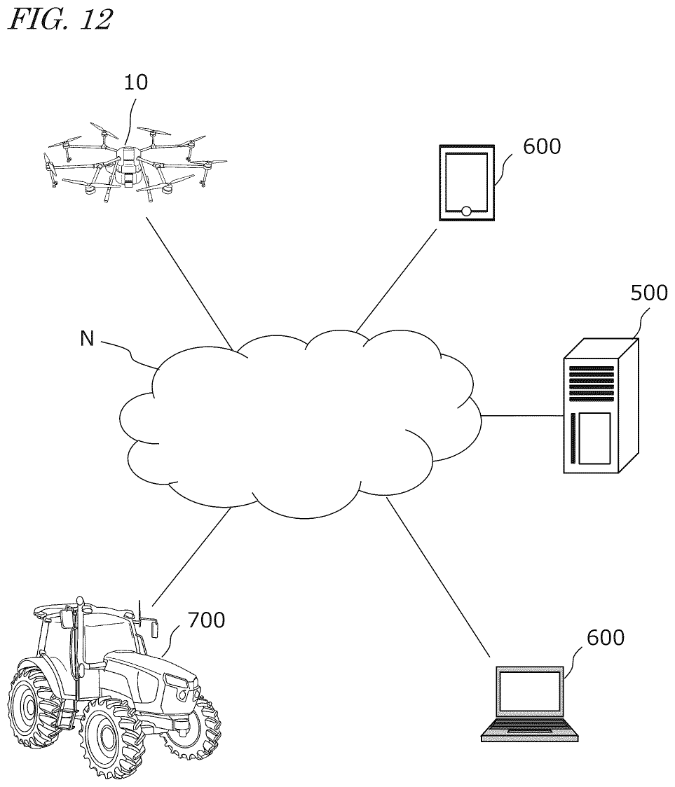

FIG. 12 is a schematic diagram showing a configuration example of a system including the multicopter 10. Some or all of the functions of the controller 4a may include one or more servers (computers) 500 or terminal devices (including portable and fixed types) 600 connected to the communication device 4c of the multicopter 10 via a communication network N. Agricultural machines 700 such as tractors may be connected to this communication network N, and communication may be performed between the multicopter 10 and the agricultural machines 700. Through the communication network N, some of the data used for processing by the controller 4a and control signals for the multicopter 10 may be provided to the multicopter 10 from the agricultural machines 700.

Unmanned aerial vehicles according to example embodiments of the present disclosure may be widely utilized not only for applications such as aerial photography, surveying, logistics, and agricultural spraying, but also for ground work related to agricultural work, and transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising:
a body;
an obstacle sensor attached to the body; and
a controller configured or programmed to:
perform an obstacle avoidance function to detect an obstacle based on a signal output from the obstacle sensor and to perform an operation to avoid collision with the obstacle;
disable the obstacle avoidance function when a predetermined condition is satisfied; and
enable the obstacle avoidance function when the predetermined condition is not satisfied; wherein
the predetermined condition includes at least one of:
a first condition that a tilt angle of the body is greater than a predetermined angle;
a second condition that the unmanned aerial vehicle is in a takeoff operation or a landing operation; or
a third condition that an altitude of the body is at or below a predetermined height.

2. The unmanned aerial vehicle according to claim 1, wherein the predetermined condition includes the first condition and the second condition, and does not include the third condition.

3. The unmanned aerial vehicle according to claim 1, wherein the predetermined condition includes the second condition and the third condition, and does not include the first condition.

4. The unmanned aerial vehicle according to claim 1, wherein the predetermined condition includes all of the first, second, and third conditions.

5. The unmanned aerial vehicle according to claim 1, wherein the obstacle sensor is positioned to detect an object located horizontally away from the body when the body is not tilted.

6. The unmanned aerial vehicle according to claim 1, wherein the obstacle sensor includes a laser sensor fixed to the body so as to emit a light beam toward the object located horizontally away from the body when the body is not tilted.

7. The unmanned aerial vehicle according to claim 1, wherein the obstacle sensor includes an imager fixed to the body so as to capture an image of the object located horizontally away from the body when the body is not tilted.

8. The unmanned aerial vehicle according to claim 1, wherein
the obstacle sensor is configured to output a signal indicating a distance to an object within a measurement range; and
the controller is configured or programmed to:
determine that an obstacle has been detected if the distance indicated by the signal is less than a threshold value; and
set the threshold value based on the tilt angle and the altitude.

9. The unmanned aerial vehicle according to claim 8, wherein, when the tilt angle is θ and the altitude is h, the controller is configured or programmed to vary the threshold value according to the value of h/sin θ.

10. The unmanned aerial vehicle according to claim 1, further comprising a distance sensor configured to measure a distance to the object existing below the body as the altitude.

11. A control system for an unmanned aerial vehicle including a body and an obstacle sensor attached to the body, the control system comprising:
a controller configured or programmed to:
control operation of the unmanned aerial vehicle;
perform an obstacle avoidance function to detect an obstacle based on a signal output from the obstacle sensor and to perform an operation to avoid collision with the obstacle;
disable the obstacle avoidance function when a predetermined condition is satisfied; and
enable the obstacle avoidance function when the predetermined condition is not satisfied; wherein
the predetermined condition includes at least one of:
a first condition that a tilt angle of the body is greater than a predetermined angle;
a second condition that the unmanned aerial vehicle is in a takeoff operation or a landing operation; or
a third condition that an altitude of the body is at or below a predetermined height.

12. A control method for an unmanned aerial vehicle including a body and an obstacle sensor attached to the body, the method comprising:
detecting an obstacle based on a signal output from the obstacle sensor;
causing the unmanned aerial vehicle to perform an obstacle avoidance operation to avoid collision with the obstacle when an obstacle is detected;
disabling the obstacle avoidance operation when a predetermined condition is satisfied; and
enabling the obstacle avoidance operation when the predetermined condition is not satisfied; wherein
the predetermined condition includes at least one of:
a first condition that a tilt angle of the body is greater than a predetermined angle;
a second condition that the unmanned aerial vehicle is in a takeoff operation or a landing operation; or
a third condition that an altitude of the body is at or below a predetermined height.
